(19) United States
(12) Patent Application Publication
(10) Pub. No.: US 2025/0371992 A1
(43) Pub. Date: Dec. 4, 2025

(54) SYSTEMS AND METHODS FOR ADVANCED LEARNING ENGINES

(71) Applicant: Erik Lech, Litchfield Park, AZ (US)

(72) Inventor: Erik Lech, Litchfield Park, AZ (US)

(21) Appl. No.: 19/226,054

(22) Filed: Jun. 2, 2025

Related U.S. Application Data
(60) Provisional application No. 63/655,291, filed on Jun. 3, 2024.

(51) Int. Cl. G09B 7/00; G06N 3/044

(52) U.S. Cl. CPC G09B 7/00; G06N 3/044

(57) ABSTRACT

An advanced learning engine (ALE) can receive first input data from a student device at a first time. The ALE can generate an insight based on a comparison of the first input data with a digital twin database that includes at least one of persona data, personality trait data, interest data, and skill data. The ALE can generate a story script based on the insight. The ALE can transmit the story script to the student device. The ALE can receive second input data from the student device at a second time and update the insight in real time based on the second student input.

### CROSS-REFERENCE TO RELATED APPLICATION

This application claims priority to, and the benefit of, U.S. Provisional Patent Application Ser. No. 63/655,291, entitled “SYSTEMS AND METHODS FOR ADVANCED LEARNING ENGINES,” filed on Jun. 3, 2024. The '291 Application is hereby incorporated by reference in its entirety for all purposes.

### TECHNICAL FIELD

The present disclosure relates generally to systems for customized learning environments and, more specifically, to customized learning environment systems including live user-system interactions for user experience optimization.

### BACKGROUND

Electronic educational service delivery is increasingly important as educational modalities continue to evolve. Digital learning environments are convenient to deploy, scale, and update. Moreover, digital delivery is accessible to all, from urban classrooms to rural schoolhouses, as well as portable, traveling with the student and providing education where the student is. However, currently, digital learning environments are static and difficult to customize both to a student and to accommodate changing local educational standards.

### SUMMARY

In general, one aspect of the subject matter described in this disclosure may be embodied in a system including an advanced learning engine. The advanced learning engine includes a processor. The advanced learning engine is configured to communicate with a student device. The system further includes a non-transitory, machine-readable memory in communication with the advanced learning engine and having instructions recorded thereon that, in response to execution by the advanced learning engine, cause the advanced learning engine to perform operations. The operations include receiving, by the advanced learning engine, first input data from the student device. The operations further include generating an insight, by the advanced learning engine, based on a comparison of the first input data with at least one of persona data, personality trait data, interest data, and skill data. The operations further include conforming, by the advanced learning engine, a standards-based training unit to the insight. The operations further include generating, by the advanced learning engine, a story script based on the conforming. The operations further include transmitting, by the advanced learning engine, the story script to the student device.

In another aspect, the subject matter may be embodied in an article of manufacture. The article of manufacture includes a non-transitory, machine-readable memory having instructions recorded thereon that, in response to execution by an advanced learning engine, cause the advanced learning engine to perform operations including receiving, by the advanced learning engine, first input data from a student device, generating an insight, by the advanced learning engine, based on a comparison of the first input data with at least one of persona data, personality trait data, interest data, and skill data, conforming, by the advanced learning engine, a standards-based training unit to the insight, generating, by the advanced learning engine, a story script based on the conforming, and transmitting, by the advanced learning engine, the story script to the student device.

These and other embodiments may optionally include on or more of the following features. In various aspects, the generating an insight further comprises assigning the at least one of the persona data, the personality trait data, the interest data, and the skill data to a student profile. In various aspects, the standards based training unit is at least one of common core state standards, next generation Science Standards, College, Career, and Civic Life (C3) Framework for Social Studies State Standards, English Language Proficiency Standards (ELP), National Core Arts Standards, English Language Arts State Standards, State-Specific Mathematics Standards, State-Specific Social Studies Standards, National Standards for Physical Education, an enterprise criteria, a home school curriculum, or a trade-specific criteria. In various aspects, the generating, by the advanced learning engine, the story script further includes identifying, by the advanced learning engine, a curricular area of concern based on the insight and developing, by the advanced learning engine, the story script to address the curricular area of concern. In various aspects, the operations further include receiving, by the advanced learning engine and through an application programming interface (API), additional data associated with the student profile.

In another aspect, the subject matter may be embodied in a method. The method includes receiving, by an advanced learning engine, first input data from a student device. The method further includes generating an insight, by the advanced learning engine, based on a comparison of the first input data with at least one of persona data, personality trait data, interest data, and skill data. The method further includes conforming, by the advanced learning engine, a standards-based training unit to the insight. The method further includes generating, by the advanced learning engine, a story script based on the conforming. The method further includes transmitting, by the advanced learning engine, the story script to the student device.

In another aspect, the subject matter may be embodied in a system. The system includes an advanced learning engine comprising a processor, the advanced learning engine configured to communicate with a student device. The system further includes a non-transitory, machine-readable memory in communication with advanced learning engine having instructions recorded thereon that, in response to execution by the advanced learning engine, cause the advanced learning engine to perform operations. The operations include receiving, by the advanced learning engine, first input data from the student device. The operations further include generating an insight, by the advanced learning engine, based on a comparison of the first input data with at least one of persona data, personality trait data, interest data, and skill data. The operations further include generating, by the advanced learning engine, a digital twin data that includes the at least one of persona data, personality trait data, interest data, and skill data. The operations further include generating, by the advanced learning engine, a story script based on the digital twin data. The operations further include transmitting, by the advanced learning engine, the story script to the student device. In various aspects, the operations further include updating, by the advanced learning engine, the digital twin data based on a second input received from the user device.

In another aspect, the subject matter may be embodied in an advanced learning system including a transform engine, a translator engine, and a compiler. The transformer engine is configured to receive a first input data from a user device, generate a digital twin data based on the first input data, the digital twin data includes at least one of persona data, personality trait data, interest data, and skill data, and adjust a base script based on the digital twin data to generate a personalized script. The translator engine is configured to receive a request from the transformer engine based on the personalized script, and, in response to receiving the request, search for at least one of an image object; a 3D object, an audio object, or a video object. The searching can include searching a library database for the at least one of the image object; the 3D object, the audio object, or the video object, and/or generating, using a first machine learning architecture, the at least one of the image object; the 3D object, the audio object, or the video object. The compiler is configured to receive the at least one of the image object; the 3D object, the audio object, or the video object from the translator, generate, using a second machine learning architecture, a graphical user interface for the personalized script, and send the graphical user interface for displaying on the user device.

In various aspects, the compiler is further configured to modify the personalized script based on a standards-based training unit, a current event, and/or a current trend.

In another aspect, the subject matter may be embodied in an article of manufacture including a non-transitory, machine-readable memory having instructions recorded thereon that, in response to execution by an advanced learning engine, cause the advanced learning engine to perform operations. The operations include receiving, by the advanced learning engine, first input data from a student device at a first time. The operations include generating an insight, by the advanced learning engine, based on a comparison of the first input data with at least one of persona data, personality trait data, interest data, and skill data. The operations include generating, by the advanced learning engine, a story script based on the insight. The operations include transmitting, by the advanced learning engine, the story script to the student device. The operations include receiving, by the advanced learning engine, second input data from the student device at a second time. The operations include updating, by the advanced learning engine, the insight in real time based on the second student input and using a machine learning architecture.

In another aspect, the subject matter may be embodied in an article of manufacture including a non-transitory, machine-readable memory having instructions recorded thereon that, in response to execution by an advanced learning engine, cause the advanced learning engine to perform operations including receiving, by the advanced learning engine, first input data from a student device at a first time, generating, by the advanced learning engine, an insight about a user of the student device, generating, by the advanced learning engine, a digital twin data that includes the insight, generating, by the advanced learning engine, a tonal persona based on the digital twin data, generating, by the advanced learning engine, a story script that utilizes the tonal persona, and sending, by the advanced learning engine, the story script to the student device.

In another aspect, the subject matter may be embodied in a system including a student wearable device, an advanced learning engine comprising a processor, the advanced learning engine configured to communicate with the student wearable device, and a non-transitory, machine-readable memory in communication with the advanced learning engine and having instructions recorded thereon that, in response to execution by the advanced learning engine, cause the advanced learning engine to perform operations. The operations includes receiving, by the advanced learning engine, a first input data from the student wearable device, generating, by the advanced learning engine, an insight based on the first input data, generating, by the advanced learning engine, a digital twin data that includes the at least one of persona data, personality trait data, interest data, and skill data, generating, by the advanced learning engine, a mechanical digital twin data that includes data about the student wearable device, generating, by the advanced learning engine, a story script based on the digital twin data and the mechanical digital twin data, and transmitting, by the advanced learning engine, the story script to the student wearable device.

In various aspects, the operations further include receiving, by the advanced learning engine, situational awareness data from the student wearable device, and modifying, by the advanced learning engine, the story script based on the situational awareness data.

The contents of this section are intended as a simplified introduction to the disclosure and are not intended to limit the scope of any claim. The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The accompanying drawings are included to provide a further understanding of the present disclosure and are incorporated in, and constitute a part of, this specification, illustrate various embodiments, and together with the description, serve to explain exemplary principles of the disclosure.

FIG. 1 illustrates an advanced learning system in accordance with various embodiments;

FIG. 2 illustrates an advanced learning infrastructure in accordance with various embodiments;

FIG. 3 illustrates a dynamic script generation process in accordance with various embodiments;

FIG. 4 illustrates a dynamic script generation in accordance with various embodiments;

FIG. 5A illustrates various infrastructure of an advanced learning system, including a transformer engine, a translator engine, and a compiler engine, in accordance with various embodiments;

FIG. 5B illustrates aspects of a translator engine of the advanced learning system, in accordance with various embodiments;

FIG. 5C illustrates aspects of a compiler engine of the advanced learning system, in accordance with various embodiments;

FIG. 5D illustrates aspects of the advanced learning system including a central hub graphical user interface (GUI) and various platforms that can utilize the advanced learning system, in accordance with various embodiments;

FIG. 6 illustrates a method, in accordance with various embodiments; and

FIG. 7 illustrates an example virtual environment, in accordance with various embodiments.

### DETAILED DESCRIPTION

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical chemical, electrical, and mechanical changes may be made without departing from the spirit and scope of the disclosure. Thus, the detailed description herein is presented for purposes of illustration only and not of limitation.

For example, the steps recited in any of the method or process descriptions may be executed in any suitable order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Additionally, any reference to without contact (or similar phrases) may also include reduced contact or minimal contact.

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized, and that logical and mechanical changes may be made without departing from the spirit and scope of the disclosure. Thus, the detailed description herein is presented for purposes of illustration only and not for purposes of limitation.

For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. An individual component may be comprised of two or more smaller components that may provide a similar functionality as the individual component. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Use of ‘a’ or ‘an’ before a noun naming an object shall indicate that the phrase be construed to mean ‘one or more’ unless the context sufficiently indicates otherwise. For example, the description or claims may refer to a processor for convenience, but the invention and claim scope contemplates that the processor may be multiple processors. The multiple processors may handle separate tasks or combine to handle certain tasks. Although specific advantages have been enumerated herein, various embodiments may include some, none, or all of the enumerated advantages. A “processor” may include hardware that runs the computer program code. Specifically, the term ‘processor’ may be synonymous with terms like controller and computer and should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

The system may allow users to access data and receive updated data in real time from other users. The system may allow users to access data and receive updated data in real time from other sources, such as a digital twin database or other database having relevance to the user's situational awareness and learning objectives. The system may store the data (e.g., in a standardized format) in a plurality of storage devices, provide remote access over a network so that users may update the data in a non-standardized format (e.g., dependent on the hardware and software platform used by the user) in real time through a GUI, convert the updated data that was input (e.g., by a user) in a non-standardized form to the standardized format, automatically generate a message (e.g., containing the updated data) whenever the updated data is stored and transmit the message to the users over a computer network in real time, so that the user has immediate access to the up-to-date data. The system allows remote users to share data in real time in a standardized format, regardless of the format (e.g., non-standardized) that the information was input by the user. The system may also include a filtering tool that is remote from the end user and provides customizable filtering features to each end user. The filtering tool may provide customizable filtering by filtering access to the data. The filtering tool may identify data or accounts that communicate with the server and may associate a request for content with the individual account. The system may include a filter on a local computer and a filter on a server.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together but not be mechanically or otherwise coupled together. Coupling may be for any length of time, e.g., permanent, or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In various embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As used herein, “satisfy,” “meet,” “match,” “associated with”, or similar phrases may include an identical match, a partial match, meeting certain criteria, matching a subset of data, a correlation, satisfying certain criteria, a correspondence, an association, an algorithmic relationship, and/or the like. Similarly, as used herein, “authenticate” or similar terms may include an exact authentication, a partial authentication, authenticating a subset of data, a correspondence, satisfying certain criteria, an association, an algorithmic relationship, and/or the like.

Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodically, randomly, once, more than once, or in response to a suitable request or action. Any of the information may be distributed and/or accessed via a software enabled link, wherein the link may be sent via an email, text, post, social network input, and/or any other method.

As used herein, “electronic communication” means communication of electronic signals with physical coupling (e.g., “electrical communication” or “electrically coupled”) or without physical coupling and via an electromagnetic field (e.g., “inductive communication” or “inductively coupled” or “inductive coupling”) and/or a radio frequency (RF) communications protocol. In this regard, “electronic communication,” as used herein, includes wired and wireless communications (e.g., Bluetooth, Bluetooth LE, NFC, TCP/IP, Wi-Fi, etc.).

As used herein, “audio input device” is any suitable hardware, software, and/or database components capable of sending and receiving audio data. For example, an audio input device may comprise a wired or wireless microphone, a wired or wireless lapel microphone, a wired or wireless headset/earpiece containing a microphone, and/or the like. The audio input device is in electronic communication with a processor, a cloud processor via a network and/or a remote processor. The audio input device can include frame mounted devices aimed away or towards the operator. The frame mounted devices aimed away from the vehicle operator can be used to gather environmental noise that may be used to filter the audio input. The audio input device can also be an audio output device such as a BLUETOOTH® headset.

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, NY), various database products available from ORACLE® Corporation (Redwood Shores, CA), MICROSOFT ACCESS® or MICROSOFT SQL SERVER® by MICROSOFT® Corporation (Redmond, Washington), MYSQL® by MySQL AB (Uppsala, Sweden), MONGODB®, Redis, Apache Cassandra®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

As used herein, big data may refer to partially or fully structured, semi-structured, or unstructured data sets including millions of rows and hundreds of thousands of columns.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

One skilled in the art will also appreciate that, for security reasons, any databases, systems, devices, servers, or other components of the system may consist of any combination thereof at a single location or at multiple locations, wherein each database or system includes any of various suitable security features, such as firewalls, access codes, encryption, decryption, public and private keys, and/or the like.

As used herein the term, “engine” refers to logic embodied in hardware or software instructions, which can be written in a programming language, such as C, C++, Objective-C, COBOL, JAVA™, JAVASCRIPT®, JAVASCRIPT® Object Notation (JSON), PHP, Perl, HTML, CSS, JavaScript, Ruby, VBScript, ASPX, Microsoft.NET™ languages such as C#, and/or the like. An engine may be compiled into executable programs or written in interpreted programming languages. Software engines may be callable from other engines or from themselves. Engines described herein refer to one or more logical modules that can be merged with other engines or applications or can be divided into sub-engines. The engines can be stored in non-transitory computer-readable medium or computer storage device and be stored on and executed by one or more general purpose computers, thus creating a special purpose computer configured to provide the engine. In various aspects, an engine can include a large language model (LLM), among other components and/or functions.

As used herein, a “story script” or “script” refers to instructions for a 3D rendering engine to render a 3D environment (a scene), including imagery, text, audio (music, dialogue, sound effects, etc.), and video, on a display device. The script may include and/or embody standards-based training units and be adapted to a particular student's student profile. The script may be adapted to a particular student's learning objectives that are based on situational awareness and an evolving career/learning path that can be determined using artificial intelligence and/or machine learning. In various aspects, the instructions can also be for a 2D rendering engine to render a 2D environment.

As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, internet, personal internet device, online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system is frequently described herein as being implemented with TCP/IP communications protocols, the system may also be implemented using IPX, APPLETALK®, IPv6, NetBIOS, any tunneling protocol (e.g., IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet is generally known to those skilled in the art and, as such, need not be detailed herein.

“Cloud” or “Cloud computing” or “cloud computing infrastructure” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

Computer programs (also referred to as computer control logic) are stored in main memory and/or secondary memory. Computer programs may also be received via communications interface. These computer program instructions may be loaded onto a general-purpose computer, special purpose computer, controller, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer, controller, or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In various embodiments, software may be stored in a computer program product and loaded into a computer system using a removable storage drive, hard disk drive, or communications interface. The control logic (software), when executed by the processor or controller, causes the processor or controller to perform the functions of various embodiments as described herein. In various embodiments, hardware components may take the form of application specific integrated circuits (ASICs). Implementation of the hardware so as to perform the functions described herein will be apparent to persons skilled in the relevant art(s).

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet-based embodiment (e.g., an internet-based driving command system), an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, solid state storage media, CD-ROM, BLU-RAY DISC®, optical storage devices, magnetic storage devices, and/or the like.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like. Still further, the system could be used to detect or prevent security issues with a client-side scripting language, such as JAVASCRIPT®, VBScript, or the like.

The system and method are described herein with reference to screen shots, block diagrams and flowchart illustrations of methods, apparatus, and computer program products according to various embodiments. It will be understood that each functional block of the block diagrams and the flowchart illustrations, and combinations of functional blocks in the block diagrams and flowchart illustrations, respectively, can be implemented by computer program instructions.

In various embodiments, components, modules, and/or engines of the systems may be implemented as applications or apps. Apps are typically deployed in the context of a mobile operating system, including for example, a WINDOWS® mobile operating system, an ANDROID® operating system, an APPLE® iOS operating system, a BLACKBERRY® company's operating system, and the like. The app may be configured to leverage the resources of the larger operating system and associated hardware via a set of predetermined rules which govern the operations of various operating systems and hardware resources. For example, where an app desires to communicate with a device or network other than the mobile device or mobile operating system, the app may leverage the communication protocol of the operating system and associated device hardware under the predetermined rules of the mobile operating system. Moreover, where the app desires an input from a user, the app may be configured to request a response from the operating system which monitors various hardware components and then communicates a detected input from the hardware to the app.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows, and the descriptions thereof may make reference to user WINDOWS®/LINUX®/UNIX® applications, webpages, websites, web forms, prompts, etc. Practitioners will appreciate that the illustrated steps described herein may comprise, in any number of configurations, including the use of WINDOWS®/LINUX®/UNIX® applications, webpages, web forms, popup WINDOWS®/LINUX®/UNIX® applications, prompts, and the like. It should be further appreciated that the multiple steps as illustrated and described may be combined into single webpages and/or WINDOWS®/LINUX®/UNIX® applications but have been expanded for the sake of simplicity. In other cases, steps illustrated and described as single process steps may be separated into multiple webpages and/or WINDOWS®/LINUX®/UNIX® applications but have been combined for simplicity.

The computers discussed herein may provide a suitable website or other internet-based graphical user interface (GUI) which is accessible by users. In one embodiment, MICROSOFT® company's Internet Information Services (IIS), Transaction Server (MTS) service, and an SQL SERVER® database, are used in conjunction with MICROSOFT® operating systems, WINDOWS NT® web server software, SQL SERVER® database, and MICROSOFT® Commerce Server. Additionally, components such as ACCESS® software, SQL SERVER® database, ORACLE® software, SYBASE® software, INFORMIX® software, MYSQL® software, INTERBASE® software, etc., may be used to provide an Active Data Object (ADO) compliant database management system. In one embodiment, the APACHE® web server is used in conjunction with a LINUX® operating system, a MYSQL® database, and PHP, Ruby, and/or PYTHON® programming languages.

In various embodiments, a multi-modal vision-language model (e.g., NeVA by NVIDIA Corporation), can be used to interpret images or drawings. Tools like these can be used, not only to grade or assist an educator in spell checking and performing tasks but also provide another source of insight about the user.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

In the context of the present disclosure, methods, systems, and articles may find particular use in connection with educational service delivery. In various embodiments, an advanced learning system is provided to customize learning to a particular student while meeting selected curricular standards or other learning objectives.

An advanced learning system provides the ability to create and modify, in real time, a learning backstory (similar to a movie script and gaming environment) based not only on specific lesson objectives, but from an evolving understanding of the user (e.g., student), past, present, and future (desired and/or different outcome possibilities), and also by assessing the real time situational awareness of the user's environment, interaction, and performance.

In various aspects, the more data the advanced learning system learns about the student the more it's able to better understand how best to educate the student. In essence, the advanced learning system creates a “digital twin” that learns along with the student, determining how to optimize instruction. The advanced learning system learns upon itself for the benefit of the student and teachers. In various aspects, the advanced learning system has the ability to inquire, extract, and assess information through live user interactions that enables refinement of this conversational data with every interaction. Student/user profiles can be adjusted accordingly and ways to customize lessons are determined in real time in order to guide users along a learning path best suited for them and in a way that promotes reasoning and optimizes learning.

In various aspects, the advanced learning system enables reasoning by the learner, which derives hypothesis/predictions, which are validated, and improvements made in response—in real time. As an example, a lesson story/script (similar to a movie which incorporates multimedia) can be modified as the student progresses through a learning session.

In various aspects, the advanced learning system dynamically, in real time, determines and creates “effective actions” to enhance the user (students) understanding, comprehension, retention, appliance, etc. of learning content. This means stories and associated lessons can be modified real time by the advanced learning system with the potential to employ new content as an extension or replacement of story/lesson content, while still adhering to desired learning outcomes.

In various aspects, the advanced learning system can determine suitable characters to employ (when and how) into a story and lessons. In addition, advanced learning system has the ability to insert a user (student) character into learning environments as an addition or replacement to advanced learning system story/lessons. For instance, new story/lessons and characters could be automatically generated in real time using other learning environments such as current event backdrops.

Various aspects of the present disclosure provide an advanced learning engine system comprising an educational platform that uses artificial intelligence (AI), machine learning (ML), digital twin(s), and/or game engines to generate personalized, interactive, and/or standards-aligned learning content. Various aspects can include:

Digital Twin: A dynamic representation of a user (e.g., a student), capturing attributes like personality, interests, and learning progress.

Real-Time Personalization: A transformer engine that adapts content instantly (e.g., in real time) based on the digital twin. The transformer engine can personalize content in real time, generating story scripts, simulations, or multimedia objects. The transformer engine can be implemented on a GPU-accelerated server. The transformer engine can process digital twin data and base scripts in under 100 ms using a pre-trained large language model (LLM) fine-tuned on educational standards (e.g., Common Core). For instance, a student struggling with algebra might receive a virtual simulation of a bridge-building challenge aligned with their interest in engineering. The system can employ a lightweight MQTT-based protocol, inspired by real-time IoT data integration, to ensure rapid content updates.

Situational Awareness: Integration of real-time external data (e.g., from IoT devices such as wearables, environmental sensors, etc.) to contextualize content. The situational awareness module can integrate real-time external data to adapt content. Data sources can include geolocation APIs, weather services, and wearable devices, for example processed via an MQTT protocol to minimize latency. A rule-based engine can trigger adjustments when thresholds are met, such as modifying a science lesson to simulate a coastal ecosystem under tidal influence if a high tide is detected for a student in a coastal area. This tends to ensure content is contextually relevant, enhancing engagement.

Game Engine Integration: Rendering of immersive simulations and story scripts to enhance engagement. The ALE system can utilize a virtual simulator, such as Unreal Engine 5 for example, for photo-realistic virtual simulations, for example using Lumen for dynamic lighting and Nanite for high-resolution 3D assets (e.g., virtual labs, historical sites). The FluidFlux plugin can simulate interactive scenarios, such as physics experiments, with real-time physics-based interactions. Unity can be supported for cross-platform deployment, leveraging its asset store for educational content like 3D models of historical sites. For example, a student learning physics can interact with a virtual pendulum simulation, adjusting parameters like length and mass, guided by the digital twin's preference for hands-on learning.

Standards Compliance: Alignment with educational standards (e.g., Common Core, Next Generation Science Standards). The system can support multi-platform deployment (e.g., game consoles, VR, eLearning software). The system can employ gamification to foster critical thinking and retention.

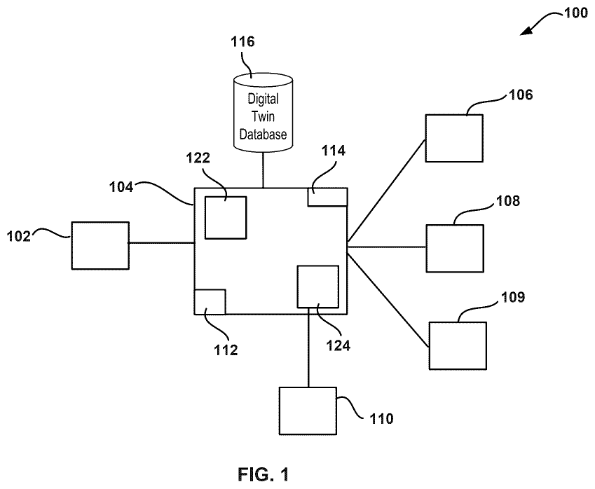

With reference to FIG. 1, an advanced learning system 100 is illustrated. The advanced learning system 100 can include an advanced learning engine 104. The advanced learning engine 104 is shown in electronic communication with a student device 102. The advanced learning engine 104 can also be in electronic communication with a standards database 106, an external student data source 108, and an employer needs database 109.

The student device 102 can include a unique identifier to associate the student device with a student profile 112 housed in the advanced learning engine 104. The student profile 112 can comprises data related to a student, including student devices, geographic location, history of interaction with advanced learning engine 104, and/or other data reflective of the student using the advanced learning system 100. The student profile 112 can be updated in real time based on student input (i.e., student interaction data), for example using an artificial intelligence architecture. The student profile 112 can include a unique identifier so that a student profile may follow a student throughout the student's interaction with advanced learning engine 104, with regard to the school or geographic location in which the student resides and/or attends in person school. The student device 102 may include one or more audio input devices as well as a display device, a camera, a keyboard, a mouse, a touchscreen interface, and/or other device that would allow a student to input data in various media. In various embodiments, a student can input data in various media (e.g., a user input device, a hologram, simulators, etc.).

The advanced learning engine 104 may be implemented on a variety of hardware and software platforms. In various embodiments, the advanced learning engine 104 may send a signal to student device 102. The advanced learning engine 104 may generate a message to send to a portal (e.g., a kiosk, a gate, a locker, an area, etc.). The portal may activate a motor, a door, and/or a lever to allow the provider access to retrieve an item and/or leave an area with the item. The message may include the transaction number, a unique identifier, the timestamp, product IDs, a portal ID, and/or the like. In various embodiments, access to the item may include opening a door, lifting a gate, providing access to an area, displaying a product, rotating a platform, dispensing a product and/or causing other mechanical or physical access that allows the user to take the purchased item and/or leave the inventory area.

The advanced learning engine 104 may include remote access to data, standardizing data and allowing remote users to share information in real time. The advanced learning engine 104 may allow users to access data (e.g., user history data, lessons, test results, etc.), and receive updated data in real time from other users. The advanced learning engine 104 may store the data (e.g., in a non-standardized format) in a plurality of storage devices, provide remote access over a network so that users may update the data that was in a non-standardized format (e.g., dependent on the hardware and software platform used by the user) in real time through a GUI, convert the updated data that was input (e.g., by a user) in a non-standardized form to the standardized format, automatically generate a message (e.g., containing the updated data) whenever the updated data is stored and transmit the message to the users over a computer network in real time, so that the user has immediate access to the up-to-date data. The advanced learning engine 104 may allow remote users to share data in real time in a standardized format, regardless of the format (e.g., non-standardized) that the information was input by the user.

The advanced learning engine 104 may be configured to allow parties to access, or be configured to send, the user's data (or other information from any suitable source that the advanced learning engine 104 determines to be relevant at the time) to various parties:

Parents/Guardians: A parent or guardian of the user can be provided access to at least some of the user's data. The advanced learning engine 104 can be configured to send user data to a parent/guardian at predetermined intervals and/or as a user progresses through a course or lesson.

Educators. The advanced learning engine 104 can be configured to send user data to an educator at predetermined intervals and/or as a user progresses through a course or lesson. In this manner, the educator can track how the user is progressing through various lessons/courses.

Industry. The advanced learning engine 104 can be configured to send user data to the user's employer or potential employer at predetermined intervals, as a user progresses through a course or lesson, and/or as the user decides. In this manner, the employer/potential employer can assess the user's skill/education level in one or more fields. In various aspects, the career path customized to the student/user can change in accordance with the student's/user's digital twin.

Government. The advanced learning engine 104 can be configured to send user data to a government entity at predetermined intervals, as a user progresses through a course or lesson, and/or as the user decides. The user data can be sent to the government entity as an authorized learning entity determines (e.g., teachers, schools, etc.). In this manner, the government entity can gain insight into the effectiveness of the course, for example by assessing a user's scores and/or the scores of multiple users in the aggregate.

User: The advanced learning engine 104 can be configured to send user data to the user at predetermined intervals and/or as the user progresses through a course or lesson. In this manner, the user can be provided with a summary of his or her progress.

The advanced learning engine 104 may include a filtering tool that is remote from the end user and provides customizable filtering features to each end user. The filtering tool may provide customizable filtering by filtering access to the data. The filtering tool may identify data or accounts that communicate with the server and may associate a request for content with the individual account. Advanced learning engine 104 may include a filter on a local computer and a filter on a server. The filtering tool may identify information or accounts that communicate with the server and associate a request for content with the individual account.

The advanced learning engine 104 may train a neural network when using artificial intelligence or machine learning. The advanced learning engine 104 may include an expanded data set of past data to train the neural network. The advanced learning engine 104 may include an expanded data set of past data to determine potential future outcomes (with probabilities) and data about how projections could be altered by the advanced learning engine 104 in providing select information/education/training to the user/student.

The expanded training set may be developed by applying mathematical algorithms to the acquired set of data. The neural network is then trained with the expanded data set using a machine learning algorithm that uses a mathematical function to adjust certain weighting. Advanced learning engine 104 may also use an iterative training algorithm to re-train with additional data, including data received from student device 102. The advanced learning engine 104 can utilize reinforcement learning models. A reinforcement learning model can involve a robot adapted specifically for the AI.

In various embodiments, the machine learning algorithm can implement one or more machine learning techniques to analyze feature vectors within a single domain or across different domains to determine the optimal clustering given a set of input nodes. Machine learning is an area of computer science in which the goal is to develop models using example observations (i.e., training data), that can be used to make predictions on new observations. The models or logic are not based on theory but are empirically based or data driven.

Machine learning can be categorized as supervised or unsupervised. In supervised learning, the training data examples contain labels for the outcome variable of interest. There are example inputs and the values of the outcome variable of interest are known in the training data. The goal of supervised learning is to learn a method for mapping inputs to the outcome of interest. The supervised models then make predictions about the values of the outcome variable for new observations. Supervised learning methods include boosting, neural networks, random forests, support vector machines, among others.

Boosting is a machine learning algorithm which finds a highly accurate hypothesis (e.g., low error rate) from a combination of many “weak” hypotheses (e.g., substantial error rate). Given a data set comprising examples within a class and not within the class and weights based on the difficulty of classifying an example and a weak set of classifiers, boosting generates and calls a new weak classifier in each of a series of rounds. For each call, the distribution of weights is updated that indicates the importance of examples in the data set for the classification. On each round, the weights of each incorrectly classified example are increased, and the weight of each correctly classified example is decreased so the new classifier focuses on the difficult examples (i.e., those examples have not been correctly classified).

Neural networks are inspired by biological neural networks and consist of an interconnected group of functions or classifiers that process information using a connectionist approach. Neural networks change their structure during training, such as by merging overlapping detections within one network and training an arbitration network to combine the results from different networks. Examples of neural network-based approaches include the multilayer neural network, the auto associative neural network, the probabilistic decision-based neural network (PDBNN), and the sparse network of winnows (SNOW).

A random forest is a machine learning algorithm that relies on a combination of decision trees in which each tree depends on the values of a random vector sampled independently and with the same distribution for all trees in the forest. A random forest can be trained for some number of trees ‘T’ by sampling ‘N’ cases of the training data at random with replacement to create a subset of the training data. At each node, a number ‘m’ of the features are selected at random from the set of all features. The feature that provides the best split is used to do a binary split on that node. At the next node, another number ‘m’ of the features are selected at random, and the process is repeated.

A support vector machine is a machine learning algorithm for calculating a boundary that best separates a set of unit data elements in an n-dimensional space into two classes. The boundary is calculated in such a manner as to maximize the distance to the boundary (margin) for each class.

In various embodiments, the advanced learning engine 104 can utilize any of these machine learning frameworks to generate a script, including story or scene elements.

The advanced learning engine 104 may be configured to include a 2D or 3D gaming engine 114. A 3D gaming engine 114 renders 2D and 3D input based on various inputs, including user control inputs and an input relating to a “map” or “script” which comprise instructions for rendering graphical objects and how a user may interact with such graphical objects during game play. A 3D gaming engine 114 may generate an image, known as a view, with a depth of field from a data representation of a 3D object. A 3D object may be represented by 3D shape data describing the form of the outer surface of the 3D object and texture data describing characteristics of the outer surface of the 3D object. A 3D gaming engine 114 may use 3D shapes and textures to generate views of 3D objects. The views may represent a specific viewpoint of the 3D object, such as a plan view or an isometric view, and a specific illumination of the 3D object, such as a backlight, a sidelight, or an ambient light view of the 3D object from the specific viewpoint.

A 3D gaming engine 114 may be accomplished by a variety of systems. One such system is a neural network. Neural networks employ one or more layers to create an output (e.g., classification) machine learning model for received inputs. Some neural networks include one or more hidden layers in addition to an output layer. The output of each hidden layer is provided as an input to the next layer in the neural network, i.e., the next hidden layer or output layer of the neural network. Each layer of the neural network generates an output from the received input in accordance with current values of a respective set of parameters. The neural network may be subject to training to improve the accuracy of the neural network output.

Various 3D gaming engines are contemplated for used in various embodiments. For example, the Unreal engine made by Epic Games is used in various embodiments. The UNITY game engine manufactured by UNITY Technologies, San Francisco, California, United States is used in various embodiments. JAVA®-based gaming engines are used in various embodiments. Various 3D gaming engines can utilize various programming or scripting language such as C++, PYTHON®, and ActionScript, in accordance with various embodiments.

ActionScript is a computer scripting language primarily used in association with the Adobe® Flash® Player platform. Within the Adobe Flash platform, ActionScript takes the form of an SWF file embedded into a web page. Originally developed by Macromedia, the language is now owned by Adobe Systems, Inc. (which acquired Macromedia in 2005). ActionScript was initially designed for controlling simple 2D vector animations made in the Adobe® Flash® platform (formerly Macromedia Flash). Recent versions added functionality allowing for the creation of Web-based games and rich Internet applications with streaming media (such as video and audio).

The advanced learning engine 104 can include and/or be in electronic communication with a digital twin database 116. The digital twin database 116 can store digital twin data comprising a dynamic representation of a user (e.g., a student), capturing attributes like personality, interests, and learning progress, as described herein in greater detail.

The advanced learning engine 104 can include and/or be in electronic communication with a transformer engine 122. The transformer engine 122 can adapt content in real time based on the digital twin data.

The advanced learning engine 104 can include and/or be in electronic communication with a situational awareness module 124. The situational awareness module 124 can adapt content based on real-time external data from one or more external data sources 110 (e.g., an IoT device).

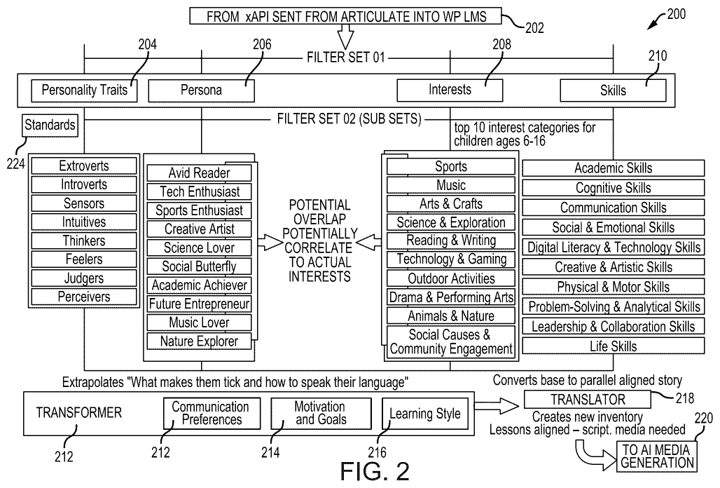

With reference to FIG. 2, advanced learning infrastructure 200 is illustrated. advanced learning infrastructure 200 may be implemented by advanced learning system 100 and, in various embodiments, advanced learning engine 104 may implement advanced learning infrastructure 200. Data received comprises from at least one of persona data 206, personality trait data 204, interest data 208, and skill data 210. Data may be received from an Experience API (xAPI) interface from various sources both within advanced learning system 100 and external to advanced learning system 100. In that regard, advanced learning system 100 may interact with other educational systems to receive various student data to both update the student profile 112 and customize the user experience for the student.

xAPI enables the collection and sharing of learning experiences and related data in a wide range of digital systems. xAPI provides a standardized way (or modifiable form) for different learning technologies to communicate with each other and track learners' activities and achievements across various platforms and devices.

xAPI moves beyond traditional learning management systems (LMS) by capturing not just formal learning activities but also informal and experiential learning experiences. It allows the collection of data on interactions, such as watching videos, reading articles, participating in simulations, completing assessments, and even real-world experiences.

The core of xAPI is based on the concept of “statements,” which consist of a subject (the learner), a verb (the action performed), and an object (the learning activity or resource). These statements are stored in a Learning Record Store (LRS), a repository that captures and stores the data generated by learning experiences. A database server, such as MONGODB® for example, can perform the functions of the LRS. In various embodiments, the advanced learning engine 104 can be incorporated into the LRS.

One of the advantages of xAPI is its flexibility and interoperability. It can track learning experiences across various platforms, including desktops, mobile devices, virtual reality systems, and even physical objects equipped with sensors. This allows for a holistic view of learners' activities and progress, regardless of the learning environment.

xAPI also enables the analysis of learning data through its ability to track a wide range of learning metrics, such as completion rates, time spent on activities, assessment scores, and even contextual data like location and device used. This data can be used to gain insights into learners' behaviors, preferences, and performance, facilitating personalized and adaptive learning approaches.

xAPI provides a standardized framework for capturing and sharing learning experiences and related data. It defines the structure and format of the statements used to describe learning activities, the communication protocols for transmitting those statements between systems, and the requirements for a Learning Record Store (LRS) that stores the collected data.

xAPI ensures that different systems can communicate with each other effectively, regardless of the platform, device, or technology being used as is our plans with XBOX, Gameboy, Netflix, Movie theaters and family gaming centers.

xAPI plays a role in establishing consistency, interoperability, and standardization in the way learning experiences and data are captured and shared within the xAPI ecosystem.

Personality trait data 204 comprises data related to the personality type of the student profile. In various embodiments, the Myers-Briggs Type Indicator (MBTI) is used to identify a person's personality type and psychological preferences as it is the most common and accepted framework within the world of psychology. The advanced learning engine's 104 “hybrid indicator framework” is programed into the xAPI throughput as an external observation, as opposed to personal self-perceived. Indicators are filtered and processed (sorted) into proper fields.

The MBTI proposes that four different cognitive functions determine one's personality (extraversion vs. introversion, sensing vs. intuition, thinking vs. feeling, and judging vs. perceiving).

In various embodiments, The Big Five model, also known as the Five-Factor Model (FFM), is used as personality trait data. FFM is a comprehensive framework that categorizes personality traits into five broad dimensions:

Openness to Experience: Reflects an individual's preference for imagination, creativity, and intellectual curiosity versus practicality and preference for routine.

Conscientiousness: Describes the degree of organization, responsibility, and self-discipline versus impulsiveness and spontaneity.

Extraversion: Indicates the level of sociability, assertiveness, and energy in social interactions versus introversion and preference for solitude.

Agreeableness: Reflects an individual's tendency to be cooperative, empathetic, and considerate versus being competitive or skeptical. Agreeableness can be dependent upon situational awareness factors. For instance, a young girl may not feel as competitive if placed in a learning environment along with boys, etc.

Neuroticism (Emotional Stability): Describes the degree of emotional stability, anxiety, and vulnerability to stress versus resilience and emotional control.

The Big Five model is widely accepted within the field of psychology due to its robustness and extensive research support. It offers a more nuanced and comprehensive understanding of personality traits compared to the MBTI.

To assess an individual's Big Five personality traits, there are several validated assessments available, such as the NEO Personality Inventory (NEO-PI) and the International Personality Item Pool (IPIP). These assessments are typically administered and interpreted by trained professionals, researchers, or psychologists to ensure accurate results and provide valuable insights into an individual's personality.

In various embodiments, revised NEO Personality Inventory (NEO-PI-R) is used as personality trait data. It is a widely used and respected personality assessment based on the Five-Factor Model (FFM), which measures an individual's personality across the following five dimensions:

Neuroticism: Reflects the tendency to experience negative emotions such as anxiety, depression, and vulnerability to stress.

Extraversion: Describes the inclination towards being outgoing, sociable, and seeking simulation from the external environment.

Openness to Experience: Indicates an individual's openness, imagination, curiosity, and willingness to explore new ideas and experiences.

Agreeableness: Measures an individual's tendency to be cooperative, compassionate, and considerate towards others.

Consciousness: Reflects the degree of organization, responsibility, self-discipline, and goal-directed behavior.

The NEO-PI-R assessment provides detailed and comprehensive information about an individual's personality traits, allowing for a more accurate understanding of their behavioral tendencies, strengths, and potential areas for growth. It is widely used in research and clinical settings and is considered a reliable and valid measure of personality.

NEO-PI-R is typically administered and interpreted by trained professionals or psychologists to ensure accurate results and proper contextualization of the assessment.

When considering personas for students, it is important to note that individual preferences and characteristics can vary widely within this age range. The personas enumerated herein may be adjusted and fine-tuned based on the specific characteristics and interests of the students as information increases and as advanced learning engine 104 evolves.

Persona data 206 comprises data related to the personality type of the student profile. In various embodiments, ten commonly observed personas include:

The Avid Reader: This persona loves books and spends a significant amount of time reading various genres. They enjoy exploring different stories, expanding their knowledge, and getting lost in imaginary worlds.

The Tech Enthusiast: This persona is fascinated by technology and enjoys exploring digital devices, apps, and games. They are curious about how things work and have a natural inclination towards coding and problem-solving activities.

The Sports Enthusiast: This persona is actively involved in sports and physical activities. They participate in team sports, have a competitive spirit, and value the benefits of exercise and teamwork.

The Creative Artist: This persona is passionate about art, whether it's drawing, painting, wring, or crafting. They enjoy expressing themselves through various media and often have a keen eye for aesthetics.

The Science Lover: This persona is curious about the natural world and enjoys conducting experiments, exploring scientific concepts, and solving puzzles. They have a strong interest in subjects like biology, chemistry, or astronomy.

The Social Butterfly: This persona is outgoing and thrives on social interactions. They enjoy making new friends, participating in group activities, and are often involved in extracurricular clubs or organizations.

The Academic Achiever: This persona is highly motivated to excel academically. They have a strong work ethic, set high standards for themselves, and are often involved in academic enrichment programs.

The Future Entrepreneur: This persona has a keen interest in entrepreneurship and business. They are often involved in projects or ventures, possess leadership qualities, and demonstrate a knack for problem-solving and critical thinking.

The Music Lover: This persona has a deep appreciation for music and enjoys playing instruments, singing, or listening to various genres. They may participate in school bands, choirs, or take private music lessons.

The Nature Explorer: This persona is fascinated by the outdoors and enjoys activities like hiking, camping, or exploring nature. They have a strong connection to the environment, appreciate wildlife, and are interested in sustainability.

Knowing a student's persona can provide several proven benefits when it comes to effective communication:

Tailored Approach: Understanding a student's persona helps in tailoring communication strategies to their specific interests, preferences, and learning styles. By aligning communication methods with their persona, you can capture their attention, engage them more effectively, and increase their receptiveness to the message being conveyed.

Building Rapport (REV): When you communicate in a way that resonates with a child's persona, you establish a stronger rapport and connection. This can foster trust, mutual understanding, and a positive relationship, making the student more likely to listen, participate, and feel comfortable expressing themselves.

Personalized Learning: By considering a student's persona, you can personalize the learning experience to match their strengths and interests. This can enhance their motivation, engagement, and overall enjoyment of the learning process.

Addressing Challenges: Different personas may face unique challenges or barriers to learning and communication. By recognizing a student's persona, you can proactively address these challenges and adapt your communication strategies accordingly. This can help overcome obstacles and ensure that the student receives the necessary support and guidance. By recognizing a student's persona and other inputs, the advanced learning engine 104 can determine (and/or suggest) possible learning difficulties and “spectrum” characteristics.

Encouraging Growth: When you communicate with a student in a way that aligns with their persona, you can encourage their personal and academic growth. By tapping into their interests, strengths, and aspirations, you can inspire them to explore new subjects, pursue their passions, and develop a positive attitude towards learning.

Conflict Resolution: Understanding a student's persona can also help in conflict resolution. By recognizing their communication style and preferences, you can approach conflicts in a more constructive and empathic manner. This can foster better communication, problem-solving, and conflict resolution skills.

Interest data 208 comprises data related to the interests of students. These vary based on individual preferences and cultural context. However, below are some commonly observed interest categories:

Sports: This category includes various physical activities such as soccer, basketball, swimming, football, baseball, gymnastics, martial arts, and more.

Music: This category encompasses interests in playing musical instruments, singing, listening to music, attending concerts, or participating in school bands or choirs.

Arts and Crafts: This category covers interests in drawing, painting, sculpting, crafting, DIY projects, and other creative endeavors.

Science and Exploration: This category includes interests in conducting experiments, exploring nature, astronomy, robotics, coding, and discovering how things work.

Reading and Writing: This category involves interests in reading books, writing stories or poetry, participating in book clubs, or engaging in creative writing activities.

Technology and Gaming: This category includes interests in digital devices, video games, coding, app development, and exploring new technologies.

Outdoor Activities: This category encompasses interests in outdoor pursuits like hiking, camping, biking, gardening, nature exploration, and adventure sports.

Drama and Performing Arts: This category involves interests in acting, theater, improvisation, dance, and participating in school plays or drama clubs.

Animals and Nature: This category includes interests in animals, wildlife conservation, zoology, environmentalism, and caring for pets.

Social Causes and Community Engagement: This category involves interests in volunteering, community service, fundraising for charitable causes, and making a positive impact on society.

The aforementioned interest categories are not mutually exclusive, and students may have overlapping interests or develop new ones over time. Understanding and supporting these interests can help educators and parents create engaging learning experiences and encourage children's personal growth and development.

Social and Emotional Development is another variable to understand a student's well-being. Understanding their social relationships, self-esteem, resilience, and emotional regulation and then addressing and supporting them can support positive mental health and enhance overall academic performance.

Skill data 210 comprises skills of various types that are potential areas of improvement for students. Through integrated mini assessments (event objectives) within the gameplay environment and external data integration, there is an ability to assess specific skills relevant to the game's learning objectives. These assessments are designed to evaluate cognitive abilities, problem-solving skills, subject-specific knowledge, and/or other targeted skills.

Skills assessed in various embodiments include:

Academic Skills: These skills encompass a wide range of subject-specific knowledge and competencies, including reading, wring, mathematics, science, social studies, languages, and other academic disciplines.

Cognitive Skills: These skills relate to cognitive abilities such as critical thinking, problem-solving, logical reasoning, creativity, decision-making, memory, and information processing.

Communication Skills: These skills involve effective verbal and written communication, listening skills, public speaking, presentation skills, and the ability to express ideas and thoughts clearly and confidently.

Social and Emotional Skills: These skills encompass social interactions, empathy, self-awareness, self-regulation, conflict resolution, teamwork, leadership, resilience, and emotional intelligence.

Digital Literacy and Technology Skills: These skills involve proficiency in using digital devices, navigating online platforms, internet research, data literacy, coding, multimedia creation, and understanding digital ethics and safety.

Creative and Arts Skills: These skills include abilities in areas such as visual arts, music, performing arts, creative wring, storytelling, design thinking, and innovation.

Physical and Motor Skills: These skills pertain to physical coordination, gross motor skills, fine motor skills, athleticism, sports, hand-eye coordination, and physical fitness.

Problem-Solving and Analytical Skills: These skills involve the ability to identify problems, analyze situations, break down complex tasks, formulate solutions, and apply critical thinking to find creative and effective solutions.

Leadership and Collaboration Skills: These skills encompass the ability to work effectively in a team, communicate ideas, negotiate, delegate tasks, inspire others, and take initiative in leading projects or group activities.

Life Skills: These skills focus on practical abilities necessary for everyday life, such as me management, organization, goal setting, financial literacy, decision-making, personal hygiene, and basic household tasks.

By considering these skill categories alongside personality, persona, and interests data collection, advanced learning engine 104 can develop a comprehensive understanding of a student's strengths, areas for growth, and potential areas for educational support and development. This information is used for the dynamic evolving curriculum design, personalized learning approaches, and targeted interventions to enhance not only the educational experience for students but the level of engagement and challenge.

Standards based training units 224 comprise various curricula and learning standards arising from industry, state governments, the federal government, and other educational organizations. Standards based training units 224 can dynamically align to unique State and National standards (examples listed below) using a national adaptive database system (NADS). Standards based training units 224 contains current standards and auto-updates as those standards change, update, are removed, or new ones are added to allow for detailed real-time adjustments to the script, including story or scene elements.

Standards cataloged include Core: Mathematics, Science, and Physics. Secondary: biology and earth sciences, fine arts, language arts, social sciences, and health.

Common Core State Standards (CCSS): The Common Core State Standards are a set of educational standards that have been adopted by a majority of states in the United States. They outline the knowledge and skills in English Language Arts (ELA) and Mathematics that students should acquire at each grade level, with a focus on critical thinking, problem-solving, and college and career readiness.

Next Generation Science Standards (NGSS): The Next Generation Science Standards provide guidelines for science education in the United States. These standards emphasize scientific practices, crosscutting concepts, and disciplinary core ideas, aiming to develop students' scientific literacy and inquiry skills.

College, Career, and Civic Life (C3) Framework for Social Studies State Standards: The C3 Framework provides guidelines for social studies education. The C3 Framework focuses on the integration of content knowledge, inquiry-based thinking, and civic engagement, aiming to develop students' understanding of history, geography, economics, and civics.

English Language Proficiency Standards (ELP): ELP standards outline the language proficiency levels and targets for English language learners (ELLs). ELP standards address students' abilities in listening, speaking, reading, and writing in English, guiding educators in supporting ELLs language development across content areas.

National Core Arts Standards: The National Core Arts Standards provide guidelines for arts education, encompassing dance, media arts, music, theater, and visual arts. These standards emphasize artistic literacy, creativity, and critical thinking, promoting students' engagement with and understanding of various art forms.

English Language Arts State Standards: In addition to the Common Core State Standards for ELA, many states have their own English Language Arts State Standards. These state-specific standards may include additional or modified expectations to align with local educational priorities.

State-Specific Mathematics Standards: Similarly, while many states have adopted the Common Core State Standards for Mathematics, some states have developed their own state-specific mathematics standards. These standards may incorporate additional topics or adjust the progression of mathematical concepts to suit the state's needs.

State-Specific Social Studies Standards: Each state in the United States typically has its own set of social studies standards that outline the expectations for history, geography, economics, and civics education. These standards can vary from state to state in terms of content, skills, and grade-level expectations.

National Standards for Physical Education: The National Standards for Physical Education outline the expectations for physical education programs. These standards focus on students' movement skills, physical fitness, and understanding of healthy living, fostering their physical literacy and overall well-being.

Enterprise Criteria: An enterprise (e.g., an employer, educator, etc.) can outline its own set of criteria for learning, depending on the enterprise's needs.

Home School Curriculum: A home school curriculum provides an education for students at home instead of sending them to a traditional public or private school. Home school curriculums can be topic specific, state-specific, or persona-specific.

Trade-specific Criteria: Learning standards can include criteria that is specific to a particular trade. Employer learning requirements can include criteria that is specific to a particular trade.

In various embodiments, persona data 206, personality trait data 204, interest data 208, and/or skill data 210 may be input into a transformer engine 222 of the advanced learning engine 104. The transformer engine 222 can receive communications preferences 212, motivation and goals 214, and learning style 216. Communications preferences 212 comprise student provided preferences relating to communications, including preferred language and preferred time of day to interact with advanced learning engine 104. Communications preferences 212 may also be determined by the presence of one or more disabilities of the student as stored in student profile 112 and/or as determined (e.g., flagged as a possibility) by the advanced learning engine 104. For example, a blind/low vision student may benefit from tactile and auditory outputs, a deaf/hard of hearing student may benefit from enhanced video displays (e.g., closed captioning or embedded American Sign Language). In that regard, accessibility of the educational materials is ensured for all students. Motivation and goals 214 may be derived from persona data 206, personality trait data 204, interest data 208, and/or skill data 210. In various embodiments, a trained neural network of advanced learning engine 104 analyzes persona data 206, personality trait data 204, interest data 208, and/or skill data 210 to determine motivations and goals. In that regard, each new determination of a motivation and/or goal may be referred to as an insight. Insights may be reflective of one or more of persona data 206, personality trait data 204, interest data 208, and/or skill data 210.

Learning style 216 may further be inferred by a trained neural network of advanced learning engine 104 based up at least one of the persona data 206, personality trait data 204, interest data 208, and/or skill data 210. Learning style 216 may be indicative of a visual learner, auditory learner, tactile learner, or the like. Learning style 216 may also be determined by the presence of one or more disabilities of the student as stored in student profile 112. In that regard, accessibility of the educational materials is ensured for all students.

The transformer engine 222 can output a translator 218. The translator 218 can take the input from the transformer engine 222 and generate a script that conforms to both the insights identified by the translator 218 and the standards-based training unit 224. In that regard, the translator 218 may use insights to adapt, create, and/or adjust one or more standards from standards-based training unit 224. The transformer engine 222 can then output instructions regarding the conformed script to the AI Media Generation 220 (also referred to herein as a compiler).

The AI Media Generation 220 can use a 3D rendering engine to transform the instructions from transformer engine 222 into a 3D rendered space for delivery to student device 102. The 3D rendered space thus furthers the mission of the standards-based training unit 224 while conforming to the insights learned from the student interaction and external data sources related to the student.

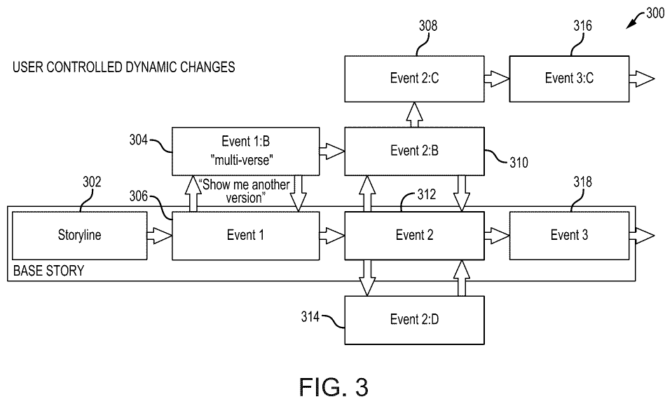

With reference to FIG. 3, dynamic script generation process 300 is illustrated. Dynamic script generation process 300 may be implemented by advanced learning engine 104 within an advanced learning infrastructure 200.

A base story script 302 embodies a standards-based training unit as well as various 3D environmental aspects, including avatars and avatar traits.

Avatars are digital representations of students and avatars may be configured to convey personality traits. For example:

Clothing and Accessories: Allow students to select clothing styles, accessories, and outfits for their avatars. The choice of clothing can indicate personal taste, fashion preferences, and even cultural influences, conveying traits like creativity, sophistication, and/or individuality.

Hairstyles and Facial Features: Provide options for different hairstyles, hair colors, facial hair, and facial features. These choices can reflect personal grooming preferences and individuality, expressing traits such as confidence, uniqueness, or trendiness.

Emotes and Gestures: Incorporate a range of emotes or gestures that users can assign to their avatars. These gestures can represent personality traits like happiness, excitement, shyness, or confidence, allowing users to convey their emotions and dispositions.

Voice and Speech Patterns: Integrate voice options or speech patterns that students can choose for their avatars. Different voice styles, tones, or accents can provide further characterization, reflecting traits such as assertiveness, warmth, intelligence, or playfulness.

Background and Environment: Allow students to select or customize the background or environment in which their avatars are displayed. The choice of settings, landscapes, or themes can hint at personality traits like adventurousness, tranquility, ambition, or creativity. The advanced learning engine 104 can update the background in real time depending upon learning needs of the user/student. As an example, if a student happens to be on a potential employer's career path (where relevant employer content may replace or enhance the learning lesson content in real time), the background may change to become the employers facilities/lab/event/SMEs, etc.

Virtual Pets or Companions: Enable students to include virtual pets or companions that accompany their avatars. The type of pet or companion chosen can indicate personality traits such as nurturing, independence, loyalty, or playfulness.

Signature or Tagline: Provide an option for students to create a signature phrase, moto, or tagline associated with their avatars. This customizable element allows students to express their personality, values, or aspirations, providing further insights into their character.

By incorporating these additional elements into avatar creation, students can further personalize and shape their avatars to reflect their desired personality traits, interests, and individuality within the virtual environment. These choices contribute to a richer and more expressive avatar representation, allowing students to create virtual personas that resonate with their own self-perception and desired image. Seeing avatars get to really know and understand how the student learns, the student may build some level of “rapport” with the avatar (perhaps similar between a great teacher and/or parent and a student).

Base story script 302 may be used in connection with multiple student profiles. Base story script 302 comprises event 1 306, event 2 312, and event 3 318. Events 306, 312, and 318 comprise a student generated data input event. In that regard, a student device 102 may transmit data relating to an interaction with a 3D environment to advanced learning engine 104. For example, the story script may solicit input from student device 102 such as in the form of a question, though in various embodiments the data from student device 102 may comprise an action of the avatar within the 3D environment. Upon receipt of the events 306, 312, and 316, advanced learning engine 104 may proceed to process the event, in whole or in part, through advanced learning infrastructure 200. Advanced learning infrastructure 200 may alter the base story script 302 and associated backdrop in response to event 1 306 to create event 1B 304. In various embodiments, event 1 306 may not lead to an alteration of the base story script 302 and thus proceeds to event 2 312. Event 1B 304 may, in turn, receive an event 2B 310. Upon receipt of event 2B 310, advanced learning engine 104 may proceed to process the event, in whole or in part, through advanced learning infrastructure 200. Advanced learning infrastructure 200 may alter the base story script 302 in response to event 2B 310 to create event 2C 308. In various embodiments, event 2B 310 may lead event 2 312 and/or event 2D 314. Event 2 312 may lease to event 318. Upon receipt of event 2C 308, advanced learning engine 104 may proceed to process the event, in whole or in part, through advanced learning infrastructure 200. Advanced learning infrastructure 200 may alter the base story script 302 in response to event 2C 308 to create event 3C 316. In various embodiments, event 1 306 may not lead to an alteration of the base story script 302 and thus proceeds to event 2 312.

In this manner, at each event, advanced learning engine 104 determines an insight via the event and updates the base story script in response to the insight and conforming to the standards-based training unit.

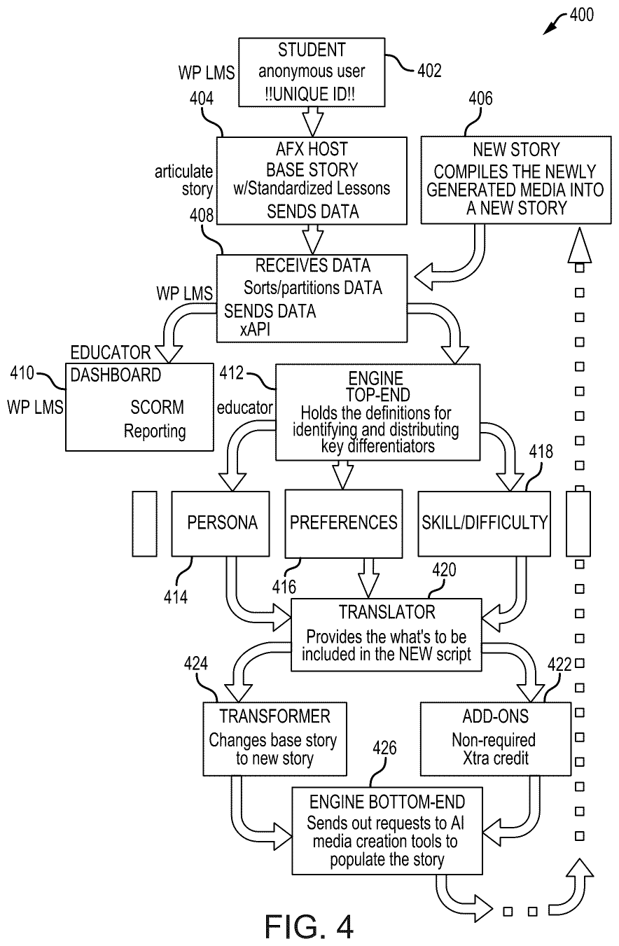

With reference to FIG. 4, dynamic script generation 400 is illustrated. A student profile may be associated with a unique ID 402 that is input into Animation Framework extension (AFX) host 404. The AFX host 404 comprises the base story script that embodies a standards-based training unit. AFX host 404 sends data to sort data step 408. At sort data step 408, data taken from the student device, including event data as described herein, is processed. A portion of that data may be sent, for example via xAPI, to educator dashboard 410. Educator dashboard 410 may comprise various dashboard tools to track student progress with respect to standard based training units. Educator dashboard 410 may further comprise dashboard tools that reflect student persona data, personality trait data, and skill data, among other things. Educator dashboard 410 may, in addition, comprise dashboard tools to show progress that a student has yet to make. Data from sort data step 408 is sent to engine top end 412. Engine top end 412 holds definitions for identifying and distributing key differentiators. For example, engine top end 412 may feed data into persona data 414, preferences 416, and skill/difficulty 418. Persona data 414, preferences 416, skill/difficulty 418 all include data derived from events provided by the student. Translator 420 takes persona data 414, preferences 416, and skill/difficulty 418 and derives an insight. The insight relates to a learning or finding about the student their preferences, their persona, their skill level, or other data related to the student. In turn, the transformer engine 424 takes the insight from translator 420 and conforms the standards-based training unit to that insight. The transformer engine 424 in effect changes the base script story to conform to the insight which will improve the student engagement in the process. Add on 422 may comprise other standards-based training units that may not necessarily be required as part of a curriculum, however they may be included as extra credit period transformer engine 424 feeds the new story to engine bottom end 426. Engine bottom end 426 sends request to API media creation tools to populate the story. This produces new story 406 which then proceeds to forward input to sort data step 408. In this regard, the dynamic script generation 400 allows for detailed real-time adjustments to the script, including story or scene elements.

With reference back to FIG. 1, in various embodiments, the advanced learning engine 104 may interact with the student device 102 to make student device 102 take certain actions. For example, student device 102 may provide haptic feedback in response to instructions from advanced learning engine 104. Moreover, student device 102 may automatically adjust a volume or brightness setting in response to advanced learning engine 104.

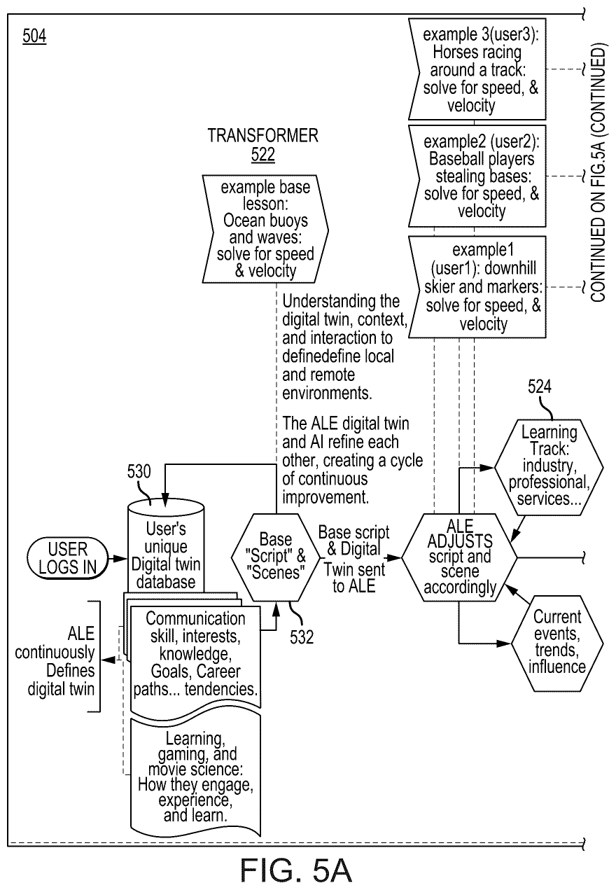

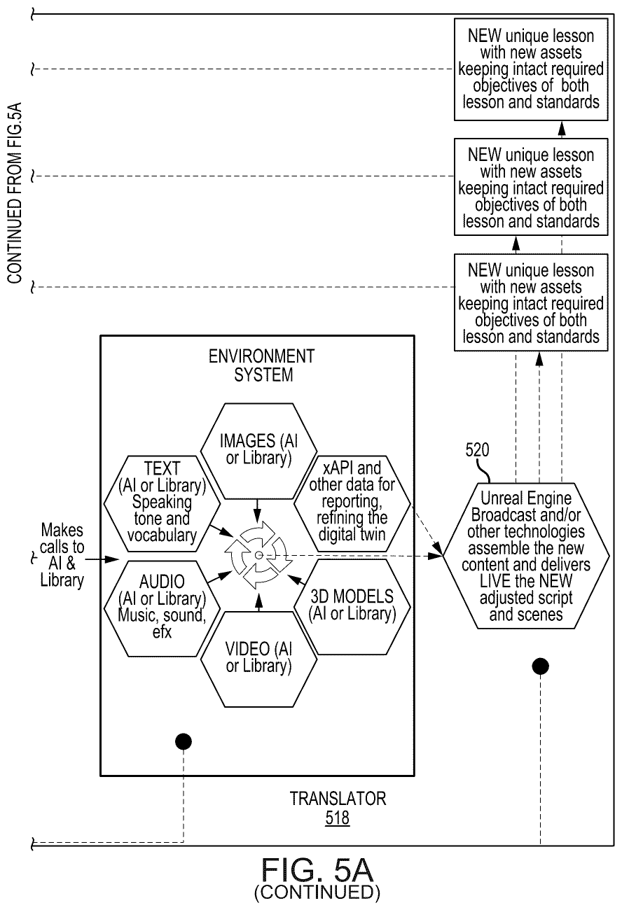

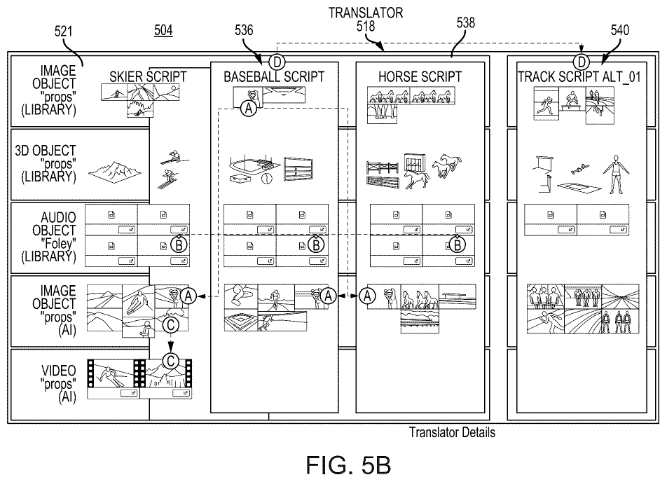

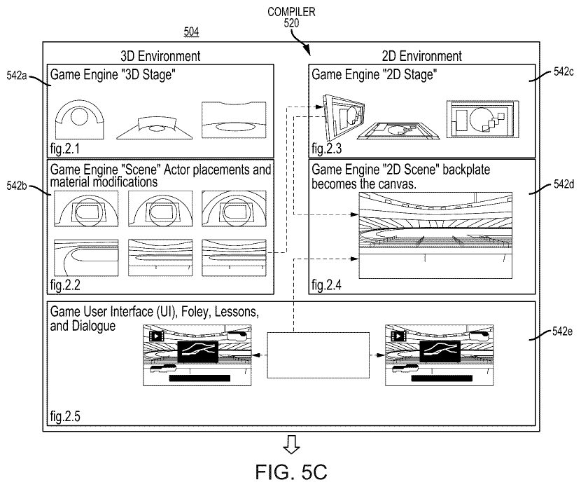

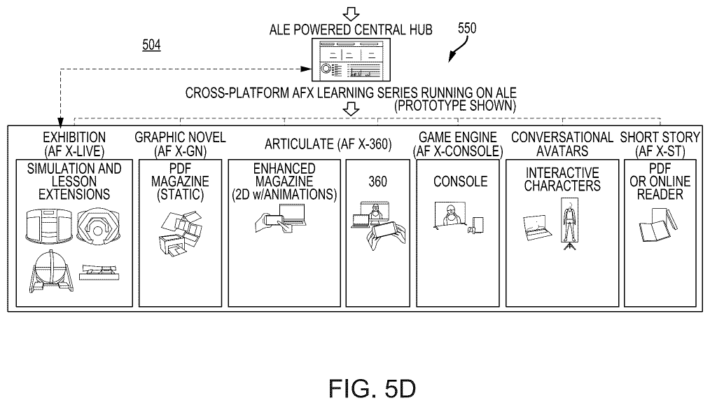

With reference to FIG. 5A through FIG. 5D, various aspects of an advanced learning engine 504 are schematically illustrated, in accordance with various embodiments. The advanced learning engine 504 can be similar to the advanced learning engine 104, in accordance with various embodiments. A user can log in to the advanced learning engine 504 and, in response, the transformer engine 522 can receive various user data and script data for generating a personalized script and associated data.

In various embodiments, the transformer engine 522 receives the user's “digital twin” data. The digital twin data can be stored in a database 530 (e.g., a user's personalized digital twin database). The digital twin data can include communication, skills, interests, knowledge, goals, career paths, tendencies, etc. of the user. The digital twin data can be continuously defined and/or updated by the advanced learning engine 504, including via artificial intelligence/machine learning. The digital twin data can include and/or be derived from personality trait data 204, persona data 206, interest data 208, and/or skill data 210, described with respect to FIG. 2. The digital twin can be a structured data model capturing student attributes (e.g., personality, interests, skills, learning progress). The digital twin data can be stored in a cloud-based NoSQL database. The digital twin data can be updated in real time using a recurrent neural network (RNN) trained on interaction logs from a user device (e.g., a student device), such as a tablet, a VR headset, etc. The digital twin data can be updated at predetermined intervals (e.g., at 10 ms intervals or any other suitable interval). Data inputs that can be used to update the digital twin data can include quiz responses, IoT devices, engagement metrics from wearable devices (e.g., heart rate), and/or historical performance. The data inputs can be validated through cross-referencing to ensure accuracy, similar to photogrammetry and IoT data validation in environmental modeling. For example, a student's preference for visual learning updates the digital twin to prioritize visual content.

In various embodiments, the transformer engine 522 receives one or more base scripts/scenes 532 for the user's learning experience. An example base script/scene can be a lesson that utilizes ocean buoys and waves that prompts the user, and/or teaches the user how, to solve for speed and velocity.

The advanced learning engine 504 utilizes a machine learning architecture to adjust and/or personalize the base script 532 based on the user's digital twin data. The digital twin data can continuously evolve with each interaction (e.g., conversation) it has with the user. For example, the advanced learning engine 504 can update the digital twin data based on user input data received from a user device. This enables the advanced learning engine 504 to continuously improve in guiding users through their learning and career paths. As such, the advanced learning engine 504 can look for patterns, inconsistencies, and right or wrong answers. The advanced learning engine 504 assistance can occur in real time, rather than at a “submit” step or asking a question directly via input box.

Furthermore, the advanced learning engine 504 can determine the best way for a user to learn a specific lesson at a specific point in time based on data obtained through real time conversations between the advanced learning engine 504 and the user (including user profile information). The advanced learning engine 504 can reference the digital twin's profile containing attributes and considerations to create “personalized” unique support in a tone, skill level, and other indicators to best communicate with that unique user.

The goal can be to guide, rather than correct. Using learning science to have the user discovery the answer leading to a deeper understanding of the subject and increased retention.

The base script 532 can be further adjusted and/or personalized based on a standards-based training units 524, which can include various curricula and/or learning standards arising from industry, state governments, the federal government, and/or other educational organizations or educational curriculum. The base script 532 can be further personalized based on current events, trends, influence, etc.

A translator 518 can take the input from the transformer engine 522 and generates a script that conforms to the insights identified by the transformer engine 522, which can include the user twin data, the standards-based training unit 524, and/or the translator 518. In that regard, translator 518 may use insights to adapt, create, and/or adjust one or more standards from standards-based training unit 524. The translator 518 may utilize a lookup table/library and/or a machine learning architecture to generate insights to adapt, create, and/or adjust one or more of text, images, audio, video, 3D models, etc. for further adjusting the script/scenes. Transformer engine 522 then outputs instructions regarding the conformed script to a compiler 520 (e.g., AI media generation). The compiler 520 can generate various personalized scripts/scenes for various types of users:

In an example, the compiler 520 can generate a personalized script/scene for a user to solve for speed and/or velocity utilizing a downhill skier and markers.

In an example, the advanced learning engine 504 can generate a personalized script/scene for a user to solve for speed and/or velocity utilizing a baseball player stealing bases.

In an example, the advanced learning engine 504 can generate a personalized script/scene for a user to solve for speed and/or velocity utilizing a horse racing around a track. The compiler 520 can keep intact desired objectives of both lesson and standards when personalizing a script/scene.

With reference to FIG. 5B, a detailed view of the translator 518 is illustrated, in accordance with various embodiments. The advanced learning engine 504 can search the unique script and extract possible scene “actors” that it determines to best fit the user. In the context of game engines and 3D modeling, actors refer to any “object” that can be placed in a scene or level of a game. For reoccurring content and building a scene on game engine platforms such as the Unreal Engine, the advanced learning engine 504 can take objects and rename them back to actors to integrate and behave properly within those systems. Therefore, actors, labeled as objects are then sorted by “type” defined by the advanced learning engine 504 environmental system's categories: images, text, audio, video, and 3D models. Using the object list generated for each script's scene, multiple sources of AI can be asked to create objects aligned to each unique instance of script. Furthermore, the advanced learning engine 504 can search existing libraries for objects.

The object list/items can be sorted to align to the appropriate AI expertise. In various embodiments, the advanced learning engine 504 can make a request for the translator 518 to: “Create movie scene objects for this script to include “object list/item” and/or “Search the library for objects for this script to include “object list/item.” The translator 518 can add the objects to the advanced learning engine library by type. The objects can be tagged to the story/script for future calls. In the event the advanced learning engine 504 determines available content as insufficient, the advanced learning engine 504 can repeat the process making a theme change.

FIG. 5B shows various scripts (i.e., a skier script 534, a baseball script 536, a horse's script 538, and a track script 540) with objects that are tagged to the story/script for future calls. Objects that can be assigned and/or tagged to the story/script include image objects (e.g., images of relevant objects for the script received from the library), 3D objects (e.g., 3D images or rendering of relevant objects for the script received from the library), audio objects (e.g., audio files of relevant audio for the script, including foley, received from the library), AI image objects (e.g., artificial intelligence-generated images of relevant objects for the script), and AI video objects (e.g., artificial intelligence-generated video of relevant objects for the script).

In an example A, an image object can be sent from the library to an artificial intelligence engine to remove and replace a background with an image/background to match the script. For example, a grey background can be replaced with a baseball field background, a horse track background, etc.

In an example B, the advanced learning engine 504 can recognize one or more audio objects that will work across several script variations and adds the media to each of these script variations.

In an example C, the advanced learning engine 504 can send an AI image object to a motion AI engine to animate the scene creating an AI video object.

In an example D, in the event the advanced learning engine 504 determines available content as insufficient, the advanced learning engine 504 can repeat the process making a theme change.

With reference to FIG. 5C, a detailed view of the compiler 520 is illustrated, in accordance with various embodiments. In various embodiments, the compiler 520 includes one or more game engines for generating 2D and/or 3D environments for the script. At block 542a, the game engine creates a “3D stage.” The 3D model and the camera positions can follow a traditional 9 film and stage positions: Center stage, center stage left, center stage right, upstage, upstage left, upstage right, downstage, downstage left, and downstage right.

At block 542b, the game engine performs scene actor placements and material modifications. This process provides deployment and engagement options from a game console, such as Xbox, to pdf, and everything in between.

At block 542c, the game engine can generate a 2D stage. The scene can be exported from the 3D environment in block 542b to a canvas in block 542c. The stage and cameras can be fixed to a center stage. The resulting image can contain image actors with motion tweens (paths) on layers above the backplate.

At block 542d, the “2D scene” backplate can become the canvas, either created from the 3D environment (shown lower right in block 542b) or as a background image object from the library or AI generation.

At block 542e, the compiler 520 can generate a game user interface, including foley, a lesson, and/or dialogue. Depending on deployment and access, the 2D version may or may not have audio objects and interactive user interface (i.e., print vs online or phone app).

The advanced learning engine 504 can use data such as live feed, video, data, and audio and data processing at the “edge” to customize the lesson in real time using data being collected from the devices as well as how the student interacts with such devices (their learning). The advanced learning engine 504 can utilize AI/machine learning at the “edge” through onsite device chips that are independent of the cloud which have the ability to reduce latency while improving privacy and data security. Since the advanced learning engine 504 can operate on data from varied sensor types, they improve analytical decision-making and intelligence for multi-sensor environments in real-time.

In addition to controlling external live environments, the advanced learning engine 504 can enable students to control elements of a virtual world (such as the Metaverse).

In various embodiments, the compiler 520 can assign interaction and xAPI behaviors to the script. The compiler 520 can connect xAPI to new instances of actors and interaction for continued digital twin definitions and improvements.

In various embodiments, the compiler 520 can generate audio visual (AV)/virtual reality (VR) and simulation-based “live” experiences. The advanced learning engine 504 can integrate live, current, relevant information to bridge reality “in the moment” with current lessons and onsite activities. Live event-based learning lessons can be connected to the classroom learning lessons, serving as an “extension” in learning and personalizing live events to the unique user.

In various embodiments, the advanced learning engine 504 can facilitate learning through simulation, AR, VR, ML, etc., enabling students to transcend into real world creation. As an example, a student could use online modeling tools to design a small race car (perhaps experimenting with combining new and existing materials), simulate its aerodynamics in a wind tunnel, 3D print the car and test in a wind tunnel, and race it in a real live event.

Intuitive Conversations, generating live relevant data, supports the learning journey and career path of the user.

The advanced learning engine 504 digital twin (and corresponding Character/Actor/Avatar which interfaces with the user/student) can get to know and relate to students very well, through ongoing live conversations (within learning lessons). The advanced learning engine 504 can refine this conversational data with every interaction and adjusts its student profile accordingly and determines ways to customize lessons in real time. This might involve gamification techniques, story-driven challenges, or immersive interactive experiences. A differential advantage that the advanced learning engine 504 has is its ability to inquire, suggest, and extract information real time from students in order to guide them along a learning path best suited for them and in a way that promotes reasoning which is important to optimize learning.

The advanced learning engine 504 can generate dynamic, two-way, live tonal persona and content using situational awareness (context) enabling intuitive conversations taking a proactive stance rather than passive striving to get user reasoning:

Example 1: “I see that you have been struggling with this for some time, even in the past,” rather than, “Let me help you with the one thing.”

Example 2: “I know you don't care for motorsports all that much, so, why don't I give you this example using horses?” Would you like that?

Example 3: “I saw in the news today that the Mars rover discovered a new bacteria. I know this is something that might interest you, so I'm mentioning it. Would you like to see more? Now or shall I store it to you notes?

PROCESS: Actor object (conversational AI character): The conversational tone and animated expressions “base” (starting point) using the real human's persona are set to the actor object. For example, a subject matter expert would start off with his or her base conversational pacing, tone, vocab, and demeanor. How you would expect him or her to react and communicate if you were to meet him or her on the street. The user's digital twin defines the ideal conversation “persona” desired from the actor object and one or more appropriate blended expressions, tone, vocab, etc. adjustments are made. For example, the digital twin can suggest the user may be sad, in the moment and/or depressed generally.

RESULT: The actor, in real time, makes appropriate adjustments such as to tone (speaking more cheerful, supportive, etc.) while also providing information (current events and historical) to promote and open doors in learning pathways to assist the user's journey

SITUATIONAL AWARENESS: The advanced learning engine 504 can generate immersive lessons using simulation/AR/AV, etc. in local and remote environments, in real time. As an example, a student could control a real operational crane on a remote oil platform to conduct lessons relevant to the ocean, energy production, etc. in real time. Situational awareness enables the experience with inputs generated from the advanced learning engine digital twin (of the user/student) and the digital twin of devices/machines/drones being controlled (and associated AR/VR, simulations, etc.). To clarify, as the user/student is controlling devices/machines/drones, etc. they (and/or the advanced learning engine) could decide at any time to concurrently use capabilities of a mechanical digital twin and simulations (AR/VR) to complement their live interaction with the advanced learning engine 504. The advanced learning engine 504 is able to obtain situational awareness information via IoT devices, such as student wearable devices, cameras, environmental sensors, etc.

Situational Awareness can refer to three ascending levels:
1. Perception of the elements in the environment,
2. Comprehension or understanding of the situation, and
3. Projection of future status.
   To achieve the highest level of situational awareness, not only does one perceive the relevant information for their goals and decisions but are also able to integrate that information to understand its meaning or significance and are able to project likely or possible future scenarios. These higher levels of situational awareness are desirable for proactive decision making in demanding environments.

Situational Awareness examples from a functional perspective include:

EXAMPLE 1: Situational Awareness data could be obtained from devices/sensors in a student's immediate environment. As an example, perhaps a learning lesson is being conducted in a laboratory where various chemical sensors are present (wearable or stationary) that are pertinent to the lesson. Such a chemical sensor could provide data that impacts learning lesson inputs and outputs (such as too high temperatures could impact chemical reactions the student is undertaking). The student's Digital Twin could advise the student and potentially take safety measures to abort or change the lesson (script/scene) in real time.

EXAMPLE 2: Situational Awareness could also be student experiential data collected (from wearable or implanted devices) during the student's interaction with the environment and the impact it is having on the student's learning. Using the chemistry lab example, such sensors could alert the student that their health is or could be impacted based on their learning lesson and what safety steps they should take which would be conveyed with the digital twin to abort, prevent, or insert a change to the lesson script/scene.

EXAMPLE 3: Situational Awareness could also be remote relevant events such as an earthquake in Japan causing a tsunami. The advanced learning engine 504 and specifically the users Digital Twin can identify the relevance of the event to the student's profile and learning paths and determine if/how/when such information could affect a pertinent advanced learning engine 504 lesson and can alter the story, script, scene accordingly.

EXAMPLE 4: Situational Awareness could also be real time interaction between a student and a specific device (local or remote). As an example, as part of a learning lesson, the student may desire to operate an actual crane remotely in real time and sensors (of many types whether wearable or not) would provide inputs/data impacting the user's current experience as they control/operate the crane (and possible data collected from other devices the crane interacts with etc.). In addition, simulations could be conducted simultaneously to complement real time operational data. In some cases, the advanced learning engine/digital twin could communicate with a remote device's “mechanical/robotic” digital twin if one exists and is appropriate (which could facilitate simulations).

With reference to FIG. 5D, an advanced learning powered central hub 550 and multiple platforms running on, or running, the advanced learning engine 504 are illustrated, in accordance with various embodiments. The central hub 550 can include a graphical user interface that displays progress of the user, user statistics, etc. The central hub 550 can allow a user to pick up where they left off. The central hub 550 can allow for one login across multiple platforms.

In various embodiments, various cross-platform AFC learning series can run on, or run, the advanced learning engine 504, such as exhibitions (AFX-LIVE), graphic novels (AFX-GN), an eLearning authoring software such as the Articulate 360® software available from Articulate Global, Inc. of New York, N.Y. (AFX-360), a game engine (AFX-CONSOLE), a conversational avatar, a short story (AFX-ST), among others.

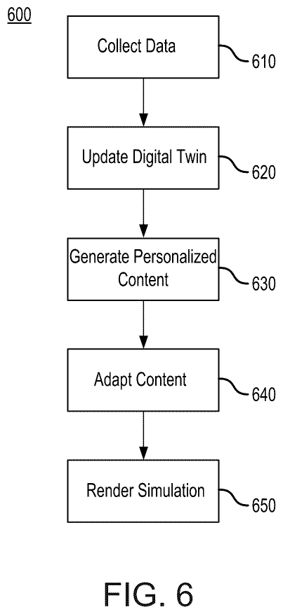

FIG. 6 is a flowchart illustrating a method 600. In various examples, the method 600 is a method for simulating a tailored learning environment. For ease of description, the method 600 is described below with reference to FIG. 1. The method 600 of the present disclosure, however, is not limited to use of the exemplary advance learning system 100 of FIG. 1.

In step 610, the method 600 includes collecting data. The advanced learning engine 104 can collect user data and/or user interaction data from the student device 102.

In step 620, the method 600 includes updating the digital twin. The advanced learning engine 104 can update the digital twin data based on user input data received from the student device 102.

In step 630, the method 600 includes generating personalized content. The transformer engine 122 can generate personalized content, such as a personalized script and associated data for example, using various user data, base script data, and/or digital twin data.

In step 640, the method 600 includes adapting content. The transformer engine 122 can adapt content (e.g., a script) in real time based on the digital twin data.

In step 650, the method 600 includes rendering a simulation. The advanced learning engine 104 can render a simulation based on the personalized content.

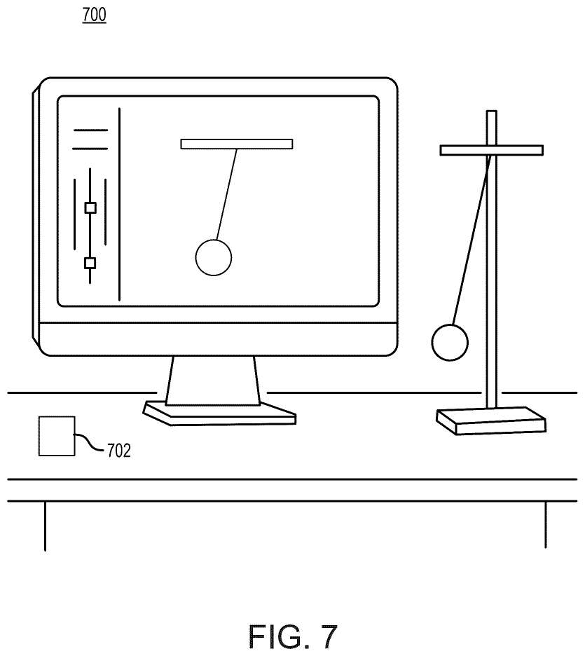

With reference to FIG. 7, a simulation of a virtual environment 700 is illustrated, in accordance with various examples. In various examples, the virtual environment 700 can be displayed on the student device 102 (see FIG. 1). The virtual environment 700 can be an interactive virtual environment. In the illustrated example, the virtual environment 700 is a physics lab with a pendulum. The virtual environment 700 is adapted in accordance with digital twin data, real-time personalization, and situational awareness contributions. For example, the virtual environment 700 can include one or more objects, such as object 702 for example, personalized in accordance with the digital twin data, real-time personalization, and/or situational awareness contributions. The object 702 can be an item, a background, a color, an environment, an event, or any other suitable feature that has been personalized and/or chosen to enhance the student's learning experience.

The ALE system can employ gamified simulations (e.g., virtual quests to solve math problems) to increase intrinsic motivation, with progress tracking and rewards fostering engagement. Real-time feedback loops, not unlike game engine dialogue systems, can provide immediate performance insights, promoting critical thinking. The system can tailor content to diverse learning styles, delivering hands-on simulations for kinesthetic learners or text-based content for auditory learners, ensuring accessibility. For instance, a biology lesson might be rendered as a virtual reality ecosystem exploration for a student who prefers immersive learning. Psychological impacts, such as enhanced retention through immersive experiences, align with educational psychology principles.

The ALE system can employ cloud-based GPU clusters for real-time rendering and data processing, with load balancing to ensure performance under high user demand. Data quality can be maintained by validating inputs through redundant sources (e.g., multiple wearables), mitigating incomplete data risks. Technical complexities, such as high-fidelity rendering and real-time data integration, can be addressed using optimized protocols like MQTT and advanced game engine features. The user-friendly interface can include drag-and-drop controls to ensure accessibility for non-technical users.

As an example, consider a student learning about ecosystems. The digital twin can indicate an interest in marine biology and a preference for hands-on learning. Situational awareness can detect the student is near a coastal area with a recent storm event via a weather API. The transformer engine can generate a virtual reality simulation of a coral reef, incorporating storm impact data, rendered in a virtual simulator (e.g., Unreal Engine with FluidFlux) for realistic water dynamics. The student can interact with the simulation, adjusting variables like water salinity, receiving real-time feedback to enhance understanding.

A system for personalized adaptive learning can comprise a processor configured to generate a digital twin of a student based on interaction data. The system can further comprise a transformer engine to personalize educational content in real time using the digital twin. The system can further comprise a situational awareness module to adapt content based on real-time external data from IoT devices. The system can further comprise a game engine to render interactive virtual simulations aligned with the personalized content.

In various examples, the game engine uses a physics-based plugin to simulate interactive learning scenarios, such as virtual experiments.

In various examples, the digital twin is updated using a recurrent neural network processing real-time student interaction data.

A method can comprise generating a digital twin of a student from input data. A method can include personalizing educational content in real time using a transformer engine and the digital twin. A method can include integrating real-time situational data from external sources via an MQTT protocol. A method can include adapting the content based on the situational data. A method can include rendering the content as an interactive simulation using a game engine.

In various examples, the situational data can include geolocation data from an IoT device, used to adapt content to local environmental conditions. In various examples, the situational data can include geolocation data from a wearable device, used to adapt content to local environmental conditions.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Methods, systems, and articles are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system comprising:
an advanced learning engine comprising a processor, the advanced learning engine configured to communicate with a student device; and
a non-transitory, machine-readable memory in communication with advanced learning engine having instructions recorded thereon that, in response to execution by the advanced learning engine, cause the advanced learning engine to perform operations comprising:
receiving, by the advanced learning engine, first input data from the student device;
generating an insight, by the advanced learning engine, based on a comparison of the first input data with at least one of persona data, personality trait data, interest data, and skill data;
generating, by the advanced learning engine, a digital twin data that includes the at least one of persona data, personality trait data, interest data, and skill data;
generating, by the advanced learning engine, a story script based on the digital twin data; and
transmitting, by the advanced learning engine, the story script to the student device.

2. The system of claim 1, wherein the operations further comprise updating, by the advanced learning engine, the digital twin data based on a second input received from the user device, and the digital twin is updated using a recurrent neural network processing real-time student interaction data.

3. The system of claim 1, wherein the operations further comprise:
updating, by the advanced learning engine, the story script based on real time external data from an IoT device; and
rendering, by the advanced learning engine, an interactive virtual simulation aligned with the digital twin data and the external data from the IoT device.

4. The system of claim 1, wherein the generating an insight further comprises assigning the at least one of the persona data, the personality trait data, the interest data, and the skill data to a student profile.

5. The system of claim 1, wherein the operations further comprise conforming, by the advanced learning engine, a standards-based training unit to the insight; and
wherein the generating, by the advanced learning engine, the story script is based at least in part on the conforming.

6. The system of claim 5, wherein the standards based training unit is at least one of common core state standards, next generation Science Standards, College, Career, and Civic Life (C3) Framework for Social Studies State Standards, English Language Proficiency Standards (ELP), National Core Arts Standards, English Language Arts State Standards, State-Specific Mathematics Standards, State-Specific Social Studies Standards, National Standards for Physical Education, an enterprise criteria, a home school curriculum, or a trade-specific criteria.

7. The system of claim 1, wherein the generating, by the advanced learning engine, the story script further comprises identifying, by the advanced learning engine, a curricular area of concern based on the insight; and
wherein the operations further comprise developing, by the advanced learning engine, the story script to address the curricular area of concern.

8. The system of claim 3, wherein the operations further comprise receiving, by the advanced learning engine and through an application programming interface (API), additional data associated with the student profile.

9. The system of claim 1, wherein the operations further comprise:
adjusting, by the advanced learning engine, a base script based on the digital twin data to generate a personalized script;
receiving, by a translator engine, a request from a transformer engine based on the personalized script; and
in response to receiving the request, searching for at least one of an image object, a 3D object, an audio object, or a video object, including at least one of:
searching a library database for the at least one of the image object; the 3D object, the audio object, or the video object; or
generating, using a first machine learning architecture, the at least one of the image object; the 3D object, the audio object, or the video object;
receiving, by a compiler, the at least one of the image object; the 3D object, the audio object, or the video object from the translator engine;
generating, using a second machine learning architecture, a graphical user interface for the personalized script; and
sending the graphical user interface for displaying on the user device.

10. The system of claim 9, wherein the compiler is further configured to modify the personalized script based on at least one of:
a standards-based training unit;
a current event; or
a current trend.

11. The system of claim 1, wherein the student device is a student wearable device, the advanced learning engine is configured to communicate with the student wearable device; and
the operations further comprise:
receiving, by the advanced learning engine, situational awareness data from an internet of things (IoT) device; and
modifying, by the advanced learning engine, the story script based on the situational awareness data.

12. The system of claim 1, wherein the first input data is received from the student device at a first time, and the operations further comprise:
receiving, by the advanced learning engine, a second input data from the student device at a second time; and
updating, by the advanced learning engine, the insight in real time based on the second input data and using a machine learning architecture.

13. The system of claim 1, wherein the operations further comprise:
generating, by the advanced learning engine, a tonal persona based on the digital twin data; and
wherein the story script utilizes the tonal persona.

14. An article of manufacture comprising:
a non-transitory, machine-readable memory having instructions recorded thereon that, in response to execution by an advanced learning engine, cause the advanced learning engine to perform operations comprising:
receiving, by the advanced learning engine, first input data from the student device;
generating an insight, by the advanced learning engine, based on a comparison of the first input data with at least one of persona data, personality trait data, interest data, and skill data;
generating, by the advanced learning engine, a digital twin data that includes the at least one of persona data, personality trait data, interest data, and skill data;
generating, by the advanced learning engine, a story script based on the digital twin data; and
transmitting, by the advanced learning engine, the story script to the student device.

15. The article of manufacture of claim 14, wherein the operations further comprise updating, by the advanced learning engine, the digital twin data based on a second input received from the user device.

16. The article of manufacture of claim 14, wherein the generating an insight further comprises assigning the at least one of the persona data, the personality trait data, the interest data, and the skill data to a student profile.

17. The system of claim 14, wherein the generating, by the advanced learning engine, the story script further comprises identifying, by the advanced learning engine, a curricular area of concern based on the insight and developing, by the advanced learning engine, the story script to address the curricular area of concern.

18. A method comprising:
receiving, by an advanced learning engine, first input data from the student device;
generating an insight, by the advanced learning engine, based on a comparison of the first input data with at least one of persona data, personality trait data, interest data, and skill data;
generating, by the advanced learning engine, a digital twin data that includes the at least one of persona data, personality trait data, interest data, and skill data;
generating, by the advanced learning engine, a story script based on the digital twin data; and
transmitting, by the advanced learning engine, the story script to the student device.

19. The method of claim 18, wherein the first input data is received from the student device at a first time, and the method further comprises:
receiving, by the advanced learning engine, a second input data from the student device at a second time; and
updating, by the advanced learning engine, the insight in real time based on the second input data and using a machine learning architecture.

20. The method of claim 18, further comprising:
rendering the story script as an interactive simulation using a game engine; and
integrating real-time situational data from one or more external sources via an MQTT protocol.
